(19) United States
(12) Patent Application Publication
(10) Pub. No.: US 2025/0084217 A1
(43) Pub. Date: Mar. 13, 2025

(54) SH-TERMINATED POLYDITHIOACETALES FOR USE IN SEALANTS

(71) Applicant: CHEMETALL GMBH, Frankfurt (DE)

(72) Inventors: Alexander KOVALENKO, Frankfurt (DE); Alexandra JOHN, Frankfurt (DE); Bjoern SIEVERS, Frankfurt (DE); Eren ESEN, Freiburg (DE); Juergen RUEHE, Freiburg (DE)

(21) Appl. No.: 18/728,962

(22) PCT Filed: Feb. 15, 2023
(86) PCT No.: PCT/EP23/53729

§ 371 Date: Jul. 15, 2024

(30) Foreign Application Priority Data
Feb. 16, 2022 (EP) 22157058.3

(51) Int. Cl. C08G 75/12; C08G 59/66; C09D 163/00

(52) U.S. Cl. CPC C08G 75/12; C08G 59/66; C09D 163/00

(57) ABSTRACT

Disclosed herein is a polycondensation method for preparing SH-terminated polymers having at least two terminal SH-groups and including sulfur-carbon-sulfur linkages in its polymer backbone, where the method includes a step of reacting at least at least one organic constituent a1 including at least one carbonyl group with at least one organic constituent a2 including at least two thiol groups, where the molar ratio r of constituent(s) a1 and a2 to each other is <1. Further disclosed herein are polymers obtained by the method, a 2K sealing system including such polymers in one of its components, a sealant composition obtained from the method, a method of sealing a substrate by making use of the sealant composition, and a sealed substrate obtained by the method.

The present invention relates to a method for preparing SH-terminated polymers having at least two terminal SH-groups, a 2K sealing system comprising such polymers in one of its components, a sealant composition obtainable therefrom, a method of sealing a substrate by making use of said sealant composition, and to a sealed substrate obtainable by this method.

### BACKGROUND OF THE INVENTION

Sealants are used for a wide range of applications. They are, e.g., relevant to the aircraft and aerospace sector, but are also widely used in the automotive sector. Sealants are further used for sealing construction elements, connection of metal sheets, for example, to existing structures, such as segments of an airplane and/or for corrosion protection in places, where for example, in the region of holes, the corrosion protection layers of the metallic elements are damaged or removed. They may also exert a temporary carrying function, for example during transportation of structures to be mounted, which have to be subsequently provided with permanent supporting connection elements.

The use of polymeric thiols and their application within sealants such as aerospace and aircraft sealants are known in the prior art. There are a number of synthetic routes available for the preparation of such polymeric thiols.

The most prominent synthesis route for the synthesis of polythioethers is the thiol-ene click chemistry route, which makes use of bis-thioles and divinylethers as starting materials. Corresponding SH-terminated polythioethers bearing in particular sulfur-carbon-oxygen units, wherein more than one carbon atoms are present between the oxygen and sulfur atoms of the aforementioned units, in their polymer backbone and being obtainable via said thiol-ene click reaction are, e.g., disclosed in U.S. Pat. No. 6,232,401 B1. For introduction of branches into the resulting polymers triallyl cyanurate (TAC) can be used as crosslinker in the thiol-ene click reaction. However, the availability of suitable raw materials to be used for this route is limited and even if an availability is given, usually comparably high costs are involved. Hence, this route is disadvantageous at least for economic reasons.

Sulfone containing polythioethers are disclosed in U.S. Pat. No. 9,540,540 B2. These polythioethers are prepared via the use of thiol-ene pre-polymers (based on bis-thiols and divinyl ethers) and divinyl sulfone. The sulfone groups are introduced for increasing the thermal stability of the resulting polymers. However, divinyl sulfone has a high hazard potential and, hence, synthetic routes employing this starting material are undesired.

Another synthetic route for the preparation of polymeric thiols is a reaction of suitable polythiols such as bis(thiols) and polyhalides such as bis(halides) in alkaline environments. The polymers disclosed in U.S. Pat. No. 6,525,168 B2 and U.S. Pat. No. 6,723,827 B2 are prepared via this route. However, polyhalides, in particular bis(halides) such as bis-chloroethyl formal, have a high hazard potential and/or are toxic and, hence, synthetic routes employing this starting material are undesired. In addition, when bis-chloroethyl formal is used, the resulting products are not stable against acidic conditions due to the presence of the formal group. For this reason also, this route is disadvantageous.

A further process for preparing thioethers is disclosed in U.S. Pat. No. 7,875,666B2 and U.S. Pat. No. 8,466,220 B2: These patents describe their synthesis via reaction of sodium hydrosulfide (NaHS), NaOH and bis-chloroethyl formal CH₂(OCH₂CH₂Cl)₂. First, a corresponding bis-thiol CH₂(OCH₂CH₂SH)₂ is formed, which then further reacts with additional bis-chloroethyl formal CH₂(OCH₂CH₂Cl)₂. Again, chloroethyl formal, but also NaHS, are toxic materials and, hence, synthetic routes employing this starting material are undesired. Further, as mentioned above the resulting products are not stable against acidic conditions due to the presence of the formal group. Therefore, this route is disadvantageous as well.

EP 3 702 348 A1 relates to thiol compounds and a synthesis method for obtaining them. The thiol compounds disclosed in EP 3 702 348 A1 can be a reaction product of a thiol and a carbonyl compound. The thiol compounds obtained in this manner are not polymers. In case non-polymeric thiol compounds such as the ones disclosed in EP 3 702 348 A1 are used for preparing sealants, an insufficient elasticity of the sealants for aerospace applications is observed, which is disadvantageous. Further, larger amounts of hardener constituents such as epoxide groups containing constituents have to be used, which is economically disadvantageous and in turn further leads to an increased number of OH-groups being present in the crosslinked network formed. This again may lead to an undesired increase of the glass transition temperature. For these reasons, respective sealants may not meet the requirements of the aerospace industry.

However, methods for preparing polymeric thiols known in the prior art are not always satisfactory in all aspects. In most of the cases the yields are not always satisfactory. Further, in some cases the methods involve more than one step, require a complex handling, require the use of high-price starting materials and/or make use of toxic or at least hazardous starting materials and/or chemicals, which is disadvantageous both from an ecological point of view and for safety reasons. In addition, not all products have a sufficient stability in particular under acidic conditions.

Thus, there is a need to provide a new method for preparing polymeric thiols, which does not have the disadvantages of the conventional methods. Further, the resulting polymers obtainable ought to be suitable to be used in sealants, in particular for the aerospace and aircraft industry, and the resulting sealants should not show any disadvantageous properties with respect to in particular water and fuel resistance and with respect to mechanical properties and, furthermore, should allow curing at a low temperature.

### Problem

It has been therefore an objective underlying the present invention to provide a new method for preparing polymeric thiols, which is simple, easy to perform, comprises as few steps as possible, is safe, and both economically and ecologically advantageous. At the same time the obtained polymeric thiols should have a sufficient acid stability, allow curing at a low temperature when incorporated into sealant compositions and the sealant compositions should not exhibit any disadvantageous properties as far as mechanical properties and water and fuel resistance of the resulting sealants are concerned.

### Solution

This objective has been solved by the subject-matter of the claims of the present application as well as by the preferred embodiments thereof disclosed in this specification, i.e., by the subject matter described herein.

A first subject-matter of the present invention is a polycondensation method for preparing an SH-terminated polymer having at least two terminal thiol groups and comprising sulfur-carbon-sulfur linkages in its polymer backbone, wherein the method comprises a step of reacting at least two constituents with each other, namely at least one organic constituent a1 preferably having an aliphatic structure and comprising at least one carbonyl group with at least one organic constituent a2 being different from constituent a1 and comprising at least two thiol groups as step 1) to prepare the SH-terminated polymer,
wherein constituent(s) a1 is/are selected from aldehydes having at least one aldehyde group, O-acetals of these aldehydes, ketones having at least one keto group, and mixtures thereof,
   wherein the two sulfur atoms of the at least two thiol groups of constituent(s) a2 are separated from each other by a linker moiety L having a chain of at least four atoms, and
   wherein the molar ratio r of constituent(s) a1 and a2 to each other is <1, preferably is in a range of from 0.82 to 0.99.

A further subject-matter of the present invention is an SH-terminated polymer obtainable by the inventive method.

A further subject-matter of the present invention is a two-component (2K) sealing system comprising components (A) and (B) being separate from each other, wherein component (A) of the sealing system comprises at least one inventive SH-terminated polymer or at least one SH-terminated polymer obtainable by the inventive method, and wherein component (B) of the sealing system comprises at least one constituent b0, which is suitable for hardening the sealant composition by at least partially inducing a chemical transformation of the at least two thiol groups of the SH-terminated polymer.

A further subject-matter of the present invention is a sealant composition, which is obtainable by mixing components (A) and (B) of the inventive sealing system with each other.

A further subject-matter of the present invention is a method of sealing an optionally pre-coated substrate comprising at least a step of applying an inventive sealant composition at least in portion onto a surface of an optionally pre-coated substrate, wherein the optionally pre-coated substrate preferably is a substrate utilizable in the aerospace and/or aircraft industry.

A further subject-matter of the present invention is a sealed substrate, obtainable by the inventive method.

A further subject-matter of the present invention is a use of the inventive sealing system or of the inventive sealant composition for providing a sealing at least in portion onto a surface of an optionally pre-coated substrate, which is utilizable in the aerospace and/or aircraft industry.

It has been in particular surprisingly found that with the inventive method SH-terminated polymers having at least two terminal thiol groups (hereinafter also referred to as polydithioacetales) can be formed in a simple and straightforward one step reaction in excellent yields, in particular from non-toxic starting materials. Since in most cases the starting materials used are furthermore volatile constituents, not even any purification step is necessary after the polydithioacetales have been formed. In all other cases performance of the synthesis in the presence of a filler such as montmorillonite has been found to be a suitable means for allowing the polydithioacetale synthesis to be carried out without any purification step such as a filtration after the polydithioacetales have been formed.

Further, it has been in particular surprisingly found that with the inventive method SH-terminated polydithioacetales exclusively or at least almost exclusively are formed without the formation of undesired cyclic dithioacetales, which is otherwise observed in case of a reaction of a short-chain thiol-groups containing constituent such as 1,2-dimercaptoethane or 1,3-dimercaptopropane with a constituent a1. It has been found that this is achieved both by using a molar excess of constituent a2 (molar ratio r as defined above is <1) and by using constituent(s) a2, wherein the two sulfur atoms of the at least two thiol groups are separated from each other by a linker moiety L having a chain of at least four atoms such as, e.g., four carbon atoms, wherein optionally one or more of these carbon atoms may be replaced by a heteroatom, which is preferably selected from O, S and N, or a corresponding heteroatom group, wherein the heteroatom of said heteroatom group is preferably selected from O, S and N.

In addition, it has been found that the inventive method allows the formation of both linear and branched polydithioacetales, depending on the number of carbonyl groups present in constituent a1 and/or on the number of thiol groups present in constituent a2.

Moreover, it has been in particular surprisingly found that with the inventive method SH-terminated polydithioacetales can be formed, which have a very good stability against hydrolysis, i.e., exhibit an excellent water resistance. Therefore, with the inventive method SH-terminated polydithioacetales can be prepared, which can inter alia be used as polymeric constituents in sealant compositions, in particular for use in the field of aircraft and aerospace industry.

It further has been found that the polydithioacetales can be chemically crosslinked with suitable hardening constituents such as constituents comprising two or more epoxide groups leading to sealants with excellent properties. It has been particularly found that that no undesired degradation after water storage was observed for sealants prepared from such sealant compositions and containing crosslinked polydithioacetales and that such sealants thus exhibit a very good water resistance.

Further, it further has been found that sealant compositions comprising the inventively prepared polydithioacetales are utilizable for, e.g., sealing the interior of fuel tanks of aircrafts, as the sealed corresponding substrates exhibit an excellent resistance to liquid media such as organic solvents and in particular fuels such as jet fuels. Hence, it has been particularly found, that sealant compositions comprising the inventively prepared polydithioacetales exhibit a high jet fuel resistance.

Additionally, it has been surprisingly found that sealant compositions comprising the inventively prepared polydithioacetales are able to provide sealed substrates exhibiting excellent physical-mechanical properties such as tensile strength and elongation at break.

Moreover, it has been surprisingly found that cured sealants comprising inventively prepared polydithioacetales using constituents a1 having an aliphatic structure have a comparably low glass transition temperature, e.g., of −25° C. or lower, which is advantageous as far as using them is concerned, in particular for the aerospace industry. It has been in particular found that that cured sealants comprising polydithioacetales using constituents a1 having an aromatic structure in turn have a much higher glass transition temperature, which is, hence, disadvantageous.

It has been further found that the sealant compositions allow an auto-catalytic rapid curing at low temperatures such as at room temperature (18 to 29° C.).

Finally, it has been found that the sealant compositions display an excellent elasticity, require less amounts of hardener constituents such as epoxide groups containing constituents to be used, which is economically advantageous, have a sufficiently low number of OH-groups being present in the crosslinked network formed and, hence, have a sufficiently low glass transition temperature, in particular, when compared to sealant compositions, which comprise non-polymeric thiol compounds such as the ones disclosed in EP 3 702 348 A1.

### DETAILED DESCRIPTION OF THE INVENTION

The term “comprising” in the sense of the present invention, in connection for example with sealant composition, preferably has the meaning of “consisting of”. With regard, e.g., to the sealant composition it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the components of the sealing system add up to 100 wt.-%, based in each case on the total weight of the respective component. Similarly, the proportions and amounts in wt.-% (% by weight) of any of the constituents given hereinafter, which are present in the sealant composition add up to 100 wt.-%, based in each case on the total weight of the composition.

### Method for Preparing the SH-Terminated Polymer and Constituents a1 and a2

The inventive method is a polycondensation method for preparing an SH-terminated polymer having at least two terminal thiol groups and comprising sulfur-carbon-sulfur linkages in its polymer backbone. The method comprises a step of reacting at least two constituents with each other, namely at least one organic constituent a1 comprising at least one carbonyl group with at least one organic constituent a2 being different from constituent a1 and comprising at least two thiol groups to prepare the SH-terminated polymer. This step is also referred to herein as step 1).

The terms “polymer” and “polymeric” in connection with the SH-terminated polymer are known to the person skilled in the art and, for the purposes of the present invention, encompasses polycondensates. The SH-terminated polymers are herein also referred to as polydithioacetales as they are prepared via a dithioacetal route from a preferably acid-catalyzed reaction of at least constituents a1 and a2 with each other.

Preferably, step 1) is catalyzed via at least one acid, more preferably by at least one inorganic acid or organic acid, even more preferably at least one inorganic acid. The acids, in particular the inorganic acids, can be liquid or used in a liquid form thereof, such as in the case of hydrochloric acid, sulfuric acid and/or phosphoric acid. The acids, in particular the inorganic acids, can alternatively or additionally, however, also be solids and used in this solid form, e.g., in the case of phyllosilicates.

For example, step 1) can be performed in the presence of at least one filler material such as a phyllosilicate material to be used as an example of a solid acid. An example of such a material is Montmorillonite® K10. This filler material can function as solid acid for catalyzing the reaction between constituents a1 and a2. The filler material does not necessarily have to be separated from the polymer in case it is desired to incorporate it later together with the polymer as filler into a sealing system and sealant composition. When at least one filler material such as a phyllosilicate material is present during the polymer synthesis, in these cases, hence, no filtration is needed. If desired, however, it can be recovered without reduced catalytic activity. After filtration, it is preferably washed with an organic solvent such as ethyl acetate several times and then collected. Later, it is preferably dried in vacuum oven for a period of 6 to 14 h (90° C., 0 mbar). Other examples of commercially available solid acid catalysts besides Montmorillonite® K10 are Amberlyst® 15 and Dowex® 50W X8.

Preferably, step 1) is performed by cooling the reaction mixture containing constituent a2, optionally at least one acid and optionally at least one organic solvent to a temperature in a range of from 10 to −10° C. such as of from 5 to −5° C., before constituent a1 is added, in particular when the optionally used at least one acid is a liquid acid Then, preferably, the reaction mixture is heated to an elevated temperature, preferably in a range of from 50 to 100° C., more preferably of from 60 to 95° C. for a period of time, preferably for 2 to 18 hours, more preferably for 2.5 to 9 hours. In case the optionally used acid at least one acid is a solid acid, constituent a1 is preferably added to the reaction mixture containing constituent a2, the at least one acid and optionally at least one organic solvent at a temperature in a range of from 15 to 35° C. After addition of constituent a1 the resulting mixture is then heated to an elevated temperature, preferably in a range of from 50 to 140° C., more preferably of from 75 to 130° C. for a period of time, preferably for 2 to 10 hours, more preferably for 2.5 to 8 hours.

In the following, an exemplary protocol for performing the inventive method is outlined: Preferably, constituent(s) a2 such as 1,8-dimercapto-3,6-dioxaoctan (DMDO) is mixed with at least one organic solvent such as 1,4-dioxane and a catalytic amount of a suitable acid such as hydrochloric acid. The reaction mixture is then cooled down, preferably under stirring, e.g., to a temperature of about 0° C. Then, constituent(s) a1 such as an aldehyde is added dropwise for a period of 15 minutes to 120 minutes such as for a period of 44 minutes. Stirring is then preferably continued at 0° C., and the reaction mixture is allowed to stand for 1 to 16 h, and then stirred for another 1 to 18 h at an elevated temperature, e.g., at a temperature between 6° and 100° C. such as at 85° C. After evaporation of the volatile constituents, e.g., by using a rotary evaporator under vacuum (˜12 mbar) at 90° C., the SH-terminated polymer is obtained. Usually, no purification of the polymer is necessary, in particular when starting material and all chemicals used are volatile.

Preferably, the number average molecular weight (Mn) of the SH-terminated polymer is in a range of from 500 to 15 000 g/mol, more preferably of from 600 to 10000 g/mol, even more preferably of from 700 to 7500 g/mol, yet more preferably of from 800 to 5000 g/mol, still more preferably of from 900 to 4500 g/mol, most preferably of from 1000 to 4000 g/mol. Mn is determined according to the method disclosed in the ‘methods’ section.

Preferably, the SH-terminated polymer has an SH-content in a range of from 1.0 wt.-% to 10.0 wt.-%, more preferably of from 1.1 to 9.5 wt.-%, even more preferably of from 1.2 to 9.0 wt.-%, still more preferably of from 1.3 to 8.5 wt.-%, yet more preferably of from 1.4 to 8.0 wt.-%, still more preferably of from 1.5 to 7.5 wt.-%, even more preferably of from 1.5 to 7.0 wt.-%, yet more preferably of from 1.5 to 6.5 wt.-%, still more preferably of from 1.5 to 6.0 wt.-%, in each case based on the total weight of the SH-terminated polymer. The SH-content is determined according to the method disclosed in the ‘methods’ section.

Preferably, the SH-terminated polymer does not comprise any sulfone groups. In particular, the SH-terminated polymer preferably is not prepared by making use of any sulfone groups containing starting material such as divinyl sulfone.

The SH-terminated polymer comprises preferably repeating sulfur-carbon-sulfur linkages in its polymer backbone. In particular, the SH-terminated polymer comprises more than one sulfur-carbon-sulfur linkages in its polymer backbone. At least a part of these sulfur-carbon-sulfur linkages is preferably present as divalent —S—CR^{x}R^{y}—S-moieties within the backbone. Each of R^{x} and R^{y} is preferably independently of one another selected from the group consisting of H, C₁-C₂₀ aliphatic radicals, C₁-C₂₀ heteroaliphatic radicals, C₃-C₂₀ cycloaliphatic radicals, 3-20 membered heterocycloaliphatic radicals, 5-20 membered aryl or heteroaryl radicals, C₃-C₂₀ cycloaliphatic radicals bonded via a C₁-10 aliphatic radical, 3-20-membered heterocycloaliphatic radicals bonded via a C₁₋₁₀-aliphatic radicals, and 5-20-membered aryl or heteroaryl radicals bonded via a C₁₋₁₀-aliphatic radicals, more preferably is selected from the group comprising H, C₁-C₂₀ aliphatic radicals, C₁-C₂₀ heteroaliphatic radicals, C₃-C₂₀ cycloaliphatic radicals, 3-20 membered heterocycloaliphatic radicals, and 5-20 membered aryl or heteroaryl radicals, even more preferably is selected from the group comprising H, C₁-C₂₀ aliphatic radicals and C₁-C₂₀ heteroaliphatic radicals, preferably with the proviso that at least one of R^{x} and R^{y} is ≠H, more preferably precisely one of R^{x} and R^{y} is ≠H.

The molar ratio r of constituent(s) a1 and a2 to each other is <1. Preferably, the molar ratio r of constituent(s) a1 to constituent(s) a2 is in a range of from 0.50 to <1, more preferably of from 0.51 to 0.99, even more preferably of from 0.52 to 0.98, yet more preferably of from 0.53 to 0.97, still more preferably of from 0.54 to 0.96, yet more preferably of from 0.55 to 0.95. The molar ratio r can be used to adjust/regulate the number average molecular weight (Mn) of the SH-terminated polymer. Since constituent a2 comprising at least two thiol groups—such as a (bis)-thiols—is, hence, always used in a molar excess, r is always <1. As r is increased Mn also increases.

Preferably, the molar ratio r of constituent(s) a1 to constituent(s) a2 is in a range of from 0.50 to <1.0, more preferably of from >0.50 to <1.0, still more preferably of from 0.60 to <1.0, yet more preferably of from 0.70 to <1.0, still more preferably of from 0.80 to <1.0, yet more preferably of from 0.82 to <1.0, even more preferably of from 0.85 to 0.99, still more preferably of from 0.86 to 0.99, yet more preferably of from 0.87 to 0.99, still more preferably of from >0.87 to 0.99.

At least one organic constituent a1 comprising at least one carbonyl group is used for preparing the SH-terminated polymer. Constituent(s) a1 is/are selected from aldehydes having at least one aldehyde group, O-acetals of these aldehydes, ketones having at least one keto group, and mixtures thereof. It is, of course, possible, that more than one constituent a1 is used. For example, it is possible to employ two constituents a1 being different from one another, e.g., one constituent a1 bearing precisely one carbonyl group such as a first aldehyde, and one constituent a1 bearing two or more carbonyl groups such as a second dialdehyde. Likewise, it is also possible to use, e.g., two constituents a1 each having precisely one carbonyl group, but still being different from one another such as one aldehyde and one ketone.

Organic constituent a1 can have an aliphatic or aromatic structure. An aliphatic structure includes both cyclic and alicyclic structures. However, alicyclic structures are preferred. An aliphatic structure may include one or more heteroatoms and/or heteroatom groups and thus encompasses a heteroaliphatic structure. An aromatic structure may include one or more heteroatoms and/or heteroatom groups and thus encompasses a heteroaromatic structure. Preferred aliphatic structures are C₁-C₂₀ aliphatic radicals, C₁-C₂₀ heteroaliphatic radicals, C₃-C₂₀ cycloaliphatic radicals, 3-20 membered heterocycloaliphatic radicals, C₃-C₂₀ cycloaliphatic radicals bonded via a C₁-10 aliphatic radical, and 3-20-membered heterocycloaliphatic radicals bonded via a C₁₋₁₀-aliphatic radicals. Preferred aromatic structures are 5-20 membered aryl or heteroaryl radicals and 5-20-membered aryl or heteroaryl radicals bonded via a C₁₋₁₀-aliphatic radicals.

In general constituents a1, which have an aliphatic structure, are preferred compared to constituents a1, which have an aromatic structure.

Examples of aldehydes and O-acetals thereof are, e.g., valeraldehyde, paraldehyde, 3-methoxybenzaldehyde, iso-butyraldehyde, 3,4-dimethoxy benzaldehyde, acetaldehyde diethyl acetal, formaldehyde diethyl acetal, 3-(methylthio) propionaldehyde, 3-(methylthio) butyraldehyde (all examples of a constituent a1 having one carbonyl group (aldehyde group) and glutaraldehyde (an example of a constituent a1 having two carbonyl groups (two aldehyde groups). Examples of ketones are, e.g., cyclohexanone and methyl-isobutyl ketone.

As mentioned before, instead of aldehydes, their O-acetals can be used, e.g., formaldehyde diethyl acetal (flammable only) instead of the very toxic formaldehyde.

Preferably, the at least one organic constituent a1 is selected from aldehydes having at least one aldehyde group, their O-acetals, and mixtures thereof, preferably wherein at least one aldehyde and/or its O-acetal is used as a first constituent a1, which has precisely one aldehyde group, and wherein optionally a further aldehyde and/or its O-acetal is used as a second constituent a1, which has two or more aldehyde groups, preferably precisely two aldehyde groups, wherein the molar amount of the first constituent a1 preferably exceeds the molar amount of the second constituent a1, more preferably wherein the molar ratio of the first constituent a1 to the second constituent a1 is in a range of from 99:1 to 20:1.

At least one organic constituent a2 comprising at least two thiol groups is used for preparing the SH-terminated polymer. It is, of course, possible, that more than one constituent a2 is used. For example, it is possible to employ two constituents a2 being different from one another, e.g., one constituent a2 bearing precisely one two thiol groups, and one constituent a2 bearing more than two thiol groups. Likewise, it is also possible to use, e.g., two constituents a2 each having precisely two thiol groups, but still being different from one another such as one aliphatic bis(thiol) and one aromatic bis(thiol).

The two sulfur atoms of the at least two thiol groups of constituent(s) a2 are separated from each other by a linker moiety L having a chain of at least four, preferably at least five and more preferably at least six, seven or eight atoms. Preferably, the two sulfur atoms are separated from each other by a linker moiety L having a chain of at least four, preferably at least five, six, seven or eight atoms, wherein said atoms are carbon atoms, wherein optionally one or more of these carbon atoms may be replaced by a heteroatom, which is preferably selected from O, S and N, or a corresponding heteroatom group, wherein the heteroatom of said heteroatom group is preferably selected from O, S and N.

Organic constituent a2 can have an aliphatic or aromatic structure. An aliphatic structure includes both cyclic and alicyclic structures. However, alicyclic structures are preferred. An aliphatic structure may include one or more heteroatoms and/or heteroatom groups and thus encompasses a heteroaliphatic structure. An aromatic structure may include one or more heteroatoms and/or heteroatom groups and thus encompasses a heteroaromatic structure.

In general constituents a2, which have an aliphatic structure, are preferred compared to constituents a2, which have an aromatic structure.

Preferably, at least one of the constituent(s) a2 used comprises divalent oxygen atoms, preferably within an aliphatic moiety thereof, more preferably comprises ether segments, even more preferably comprises ether segment of formula —[O—R^{a2}]ₙ, wherein R^{a2} is a C₂ to C₈ alkylene residue, and parameter n is an integer in the range of from 1 to 200. The presence of oxygen atoms besides sulfur atoms is advantageous for an application of the SH-terminated polymers within aerospace sealants. DMDO (1,8-dimercapto-3,6-dioxaoctan) is an example of such a constituent a2.

Examples of suitable compounds for use as constituent a2 are bis(thioles) having an aliphatic structure are depicted below:

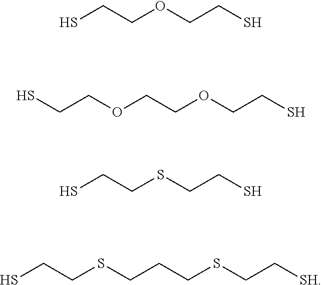 [SMILES: SCCOCCS ; SCCOCCOCCS ; SCCSCCS ; SCCSCCCSCCS]

DMDO (1,8-dimercapto-3,6-dioxaoctan) is particularly preferred. In case of DMDO the linker moiety L is the divalent —C₂H₄—O—C₂H₄—O—C₂H₄— group, which links the two thiol groups of DMDO as spacer unit. L is composed in this case of a divalent group, which is a chain having 8 atoms, namely 8 carbon atoms, wherein two of these carbon atoms are replaced by a heteroatom (oxygen atom).

Example of suitable compounds for use as constituent a2 are tris(thioles) having an aliphatic structure are depicted below:

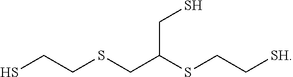 [SMILES: SCCSCC(CS)SCCS]

A further example of an aliphatic tris(thiol) to be used as constituent a2 is a tris(thiol), which is prepared by a click-reaction between at least one bis(thiol) such as DMDO and a compound bearing three ethylenically unsaturated groups such as three vinyl groups as precursor. An example of such a compound is trivinyl cyclohexane (TVCH).

The resulting tris(thiol) is prepared according to the scheme provided hereinafter, in which R is the linker moiety L connecting the two thiol groups of the bis(thiol):

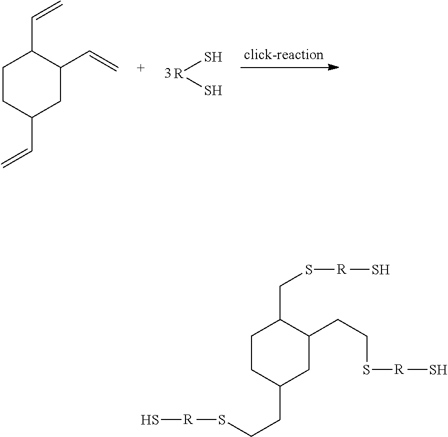

Said tris(thiol) can then be used as constituent a2 in the inventive method via the dithioacetal route. Tris(thiols) can be in particular used to generated branches into the resulting polymers.

Examples of suitable compounds for use as constituent a2 are bis(thioles) and tris(thioles) having an aromatic structure are depicted below:

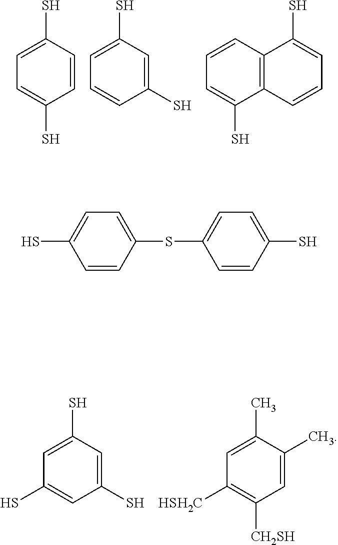

A further example of an aromatic tris(thiol) to be used as constituent a2 is a tris(thiol), which is prepared through the reaction of at least one bis(thiol) such as DMDO and cyanuric chloride, preferably in the presence of a base. The resulting tris(thiol) is prepared according to the scheme provided hereinafter, in which R is the linker moiety L connecting the two thiol groups of the bis(thiol):

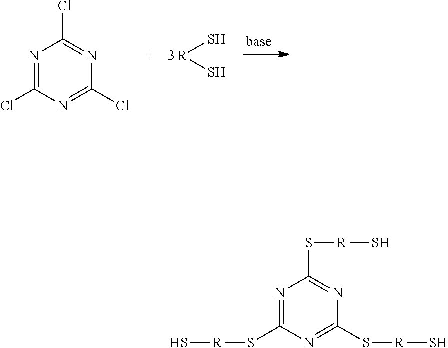

Said tris(thiol) can then be used as constituent a2 in the inventive method via the dithioacetal route. Tris(thiols) can be in particular used to generated branches into the resulting polymers, as already outlined hereinbefore.

Preferably, an aromatic tris(thiol) synthesized via a click-reaction between at least one bis(thiol) such as DMDO and triallyl cyanurate (TAC) as compound bearing three ethylenically unsaturated groups is not to be used as a constituent a2 in the inventive method, since TAC and also the resulting polymers prepared by making use of a corresponding tris(thiol) constituent a2 may not always be resistant against acidic hydrolysis, which is undesired, at least when the reaction is catalyzed by a liquid acid.

Hence, preferably, the SH-terminated preferably is not prepared by making use of TAC as starting material, either for its preparation or for preparation of any of the constituents used for preparing the polymer, at least when the reaction is catalyzed by a liquid acid.

If present, tris(thioles) are preferably only used in addition to at least one bis(thiole) as constituent(s) a2. If present, the molar amount of the tris(thiol) preferably is lower than the molar amount of the bis(thiol), more preferably is in a range of from 1:99 to 1:20 ((tris)thiol:bis(thiol)).

The SH-terminated polymer can be a linear or branched polymer.

Preferably, the SH-terminated polymer is
a linear polymer, preferably when constituent(s) a1 has/have precisely one carbonyl group and constituent (a2) has/have precisely two thiol groups, or is
a branched polymer, when (i) two kinds of constituents a1 are used and the first constituent a1 has precisely one carbonyl group and the second constituent a1 has two or more carbonyl groups, preferably precisely two carbonyl groups, wherein preferably the molar amount of the first constituent a1 exceeds the molar amount of the second constituent a1, more preferably wherein the molar ratio of the first constituent a1 to the second constituent a1 is in a range of from 99:1 to 20:1, and constituent(s) a2 has/have at least two thiol groups, preferably precisely two thiol groups, or when (ii) constituent(s) a1 has/have at least one carbonyl group, preferably precisely one carbonyl group, and at least one of the constituents a2 used has at least three thiol groups.

Hence, there are in particular two routes to introduce branches into the polymer structures: the first route (i) is via the use of constituent(s) (a1), which has/have more than one carbonyl group and the second route (ii) is via the use of constituent(s) (a2), which has/have more than two thiol groups.

Thus, if carbonyl compounds with one C(═O)-group are used as a1, the resulting polymers are substantially linear, when constituent(s) (a2) is/are used that has/have precisely two thiol groups. If carbonyl compounds with two (or more) C(═O)-groups are alternatively or additionally used as a1, the resulting polymers are branched. The use low amounts of carbonyl compounds with two (or more) C(═O)-groups as additional constituent a1—besides at least one constituent a1 having precisely one C(═O)-group—is preferred in order to introduce a certain low degree of branching as this leads to improved properties of the sealants. Preferably, the amount of an additional constituent a1 having two (or more) C(═O)-groups is in a range of from 0.1 to 10.0 mol-%, more preferably of from 0.2 to 8.0 mol-%, even more preferably of from 0.3 to 6.0 mol-%, yet more preferably of from 0.4 to 5.0 mol-%, in particular of from 0.5 to 4.0 mol-%, in each case based on the sum of all constituents a1 used for preparing the SH-terminated polymer.

Preferably, the SH-terminated polymer contains at least repeating units of the general formula (RU1), in particular when it is a linear polymer

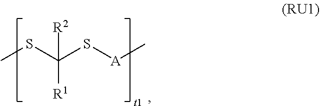

wherein
R¹ and R² together with the carbon atom connection them represent the remaining part of constituent a1 before reaction with constituent a2, i.e., constituent a1 without the oxygen atom of the formerly present carbonyl group, said carbonyl groups having been the only carbonyl group present in a1,
preferably wherein R¹ and R² independently of one another are selected from the group consisting of H, C₁-C₂₀ aliphatic radicals, C₁-C₂₀ heteroaliphatic radicals, C₃-C₂₀ cycloaliphatic radicals, 3-20 membered heterocycloaliphatic radicals, 5-20 membered aryl or heteroaryl radicals, C₃-C₂₀ cycloaliphatic radicals bonded via a C₁-10 aliphatic radical, 3-20-membered heterocycloaliphatic radicals bonded via a C₁₋₁₀-aliphatic radicals, and 5-20-membered aryl or heteroaryl radicals bonded via a C₁₋₁₀-aliphatic radicals, more preferably is selected from the group comprising H, C₁-C₂₀ aliphatic radicals, C₁-C₂₀ heteroaliphatic radicals, C₃-C₂₀ cycloaliphatic radicals, 3-20 membered heterocycloaliphatic radicals, and 5-20 membered aryl or heteroaryl radicals, even more preferably is selected from the group comprising H, C₁-C₂₀ aliphatic radicals and C₁-C₂₀ heteroaliphatic radicals, preferably with the proviso that at least one of R¹ and R² is ≠H, more preferably precisely one of R¹ and R² is ≠H,
t1 is an integer in a range of from 2 to 300, more preferably of from 3 to 200, and
variable A represents the remaining part of constituent a2 before reaction with constituent a1, i.e., constituent a2 without the thiol groups, said thiol groups having been precisely two in a2,
preferably wherein A is a divalent linker moiety L, which bears or is composed of a chain of at least four carbon atoms, wherein optionally one or more of these carbon atoms may be replaced by a heteroatom, which is preferably selected from O, S and N, or a corresponding heteroatom group, wherein the heteroatom of said heteroatom group is preferably selected from O, S and N, and optionally, in case it is a branched polymer, further comprises at least one repeating units (RU2),

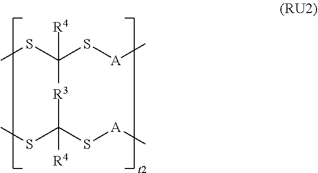

wherein
R³ and each R⁴ together with the two carbon atoms connection them represent the remaining part of constituent a1 before reaction with constituent a2, i.e., constituent a1 without each of the oxygen atoms of the formerly present two carbonyl groups, said two carbonyl groups having been the only carbonyl groups present in a1,
preferably each R⁴ independently of one another is selected from the group consisting of H, C₁-C₂₀ aliphatic radicals, C₁-C₂₀ heteroaliphatic radicals, C₃-C₂₀ cycloaliphatic radicals, 3-20 membered heterocycloaliphatic radicals, 5-20 membered aryl or heteroaryl radicals, C₃-C₂₀ cycloaliphatic radicals bonded via a C₁-10 aliphatic radical, 3-20-membered heterocycloaliphatic radicals bonded via a C₁₋₁₀-aliphatic radicals, and 5-20-membered aryl or heteroaryl radicals bonded via a C₁₋₁₀-aliphatic radicals, more preferably is selected from the group comprising H, C₁-C₂₀ aliphatic radicals, C₁-C₂₀ heteroaliphatic radicals, C₃-C₂₀ cycloaliphatic radicals, 3-20 membered heterocycloaliphatic radicals, and 5-20 membered aryl or heteroaryl radicals, even more preferably is selected from the group comprising H, C₁-C₂₀ aliphatic radicals and C₁-C₂₀ heteroaliphatic radicals, in particular represents H, preferably R³ is a divalent residue selected from the group comprising C₁-C₂₀ aliphatic radicals, C₁-C₂₀ heteroaliphatic radicals, C₃-C₂₀ cycloaliphatic radicals, 3-20 membered heterocycloaliphatic radicals, 5-20 membered aryl or heteroaryl radicals, C₃-C₂₀ cycloaliphatic radicals bonded via a C₁₋₁₀ aliphatic radical, 3-20-membered heterocycloaliphatic radicals bonded via a C₁₋₁₀-aliphatic radicals, and 5-20-membered aryl or heteroaryl radicals bonded via a C₁₋₁₀-aliphatic radicals, more preferably selected from the group comprising C₁-C₂₀ aliphatic radicals, C₁-C₂₀ heteroaliphatic radicals, C₃-C₂₀ cycloaliphatic radicals, 3-20 membered heterocycloaliphatic radicals, and 5-20 membered aryl or heteroaryl radicals, yet more preferably selected from the group comprising C₁-C₂₀ aliphatic radicals and C₁-C₂₀ heteroaliphatic radicals,
t2 is an integer in a range of from 1 to 25, more preferably of from 1 to 10, still more preferably of from 1 to 5, in particular of from 1 to 3, and
variable A represents the remaining part of constituent a2 before reaction with constituent a1, i.e., constituent a2 without the thiol groups, said thiol groups having been precisely two in a2,
preferably wherein A is a divalent linker moiety L, which bears or is composed of a chain of at least four carbon atoms, wherein optionally one or more of these carbon atoms may be replaced by a heteroatom, which is preferably selected from O, S and N, or a corresponding heteroatom group, wherein the heteroatom of said heteroatom group is preferably selected from O, S and N.

In case the SH-terminated polymer is a linear polymer, it preferably is a polymer of general formula (1)

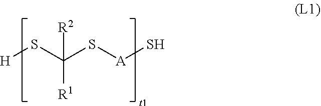

wherein R¹ and R² as well as A and t1 have the meanings as described hereinbefore.

In the scheme below an exemplary SH-terminated polymer is depicted, which is linear and prepared from DMDO as constituent a2 and an aldehyde bearing, e.g., an aliphatic residue R1 derivable from an aldehyde such as acetaldehyde or valeraldehyde bearing precisely one aldehyde group as constituent a1, wherein t1 preferably is an integer in a range of from 2 to 300 and A represents in each case a divalent —C₂H₄—O—C₂H₄—O—C₂H₄— group:

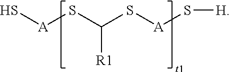

The acid-catalyzed preparation of an exemplary linear SH-terminated polymer is also illustrated in the Scheme below. Said polymer is prepared from DMDO as constituent a2 and an aldehyde bearing, e.g., an aliphatic residue R derivable from an aldehyde such as acetaldehyde or valeraldehyde bearing precisely one aldehyde group as constituent a1.

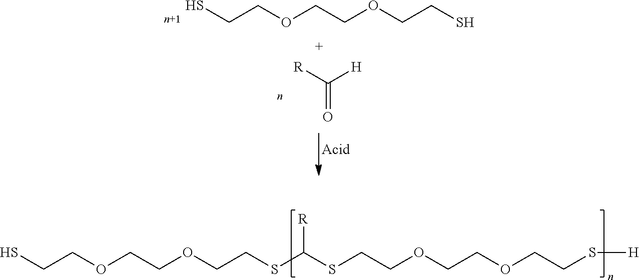

In the scheme below an exemplary SH-terminated polymer is depicted, which is branched and prepared from DMDO as constituent a2 and a first aldehyde bearing, e.g., an aliphatic residue R1 derivable from an aldehyde such as acetaldehyde or valeraldehyde bearing precisely one aldehyde group as a first constituent a1 and a second aldehyde bearing, e.g., a divalent aliphatic residue R2 such as one residue derivable from glutaraldehyde bearing two aldehyde groups as a second constituent a1, wherein A represents in each case a divalent —C₂H₄—O—C₂H₄—O—C₂H₄— group, and each of t1 to t4 t preferably is an integer in a range of from 1 to 200, wherein t1, t2, t3 and t4 may be identical or different from one another:

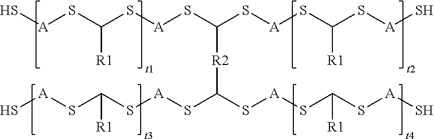

Glutaraldehyde, as a dialdehyde, in the above exemplified case, connects two polymer strands through a trimethylene bridge.

Optionally, a further constituent a3 may be used besides constituents a1 and a2 in step 1) of the inventive method, said constituent a3 being different from both constituent a1 and a2. For example, a constituent a3 bearing at least three ethylenically unsaturated groups such as at least three vinyl groups can be used. Examples of such compounds are trivinyl cyclohexane (TVCH), glyoxal bis(diallyl acetal) (as an example for a “4-arm crosslinker”) and triallyl cyanurate (TAC). The additional presence of such a constituent a3 allows performance of a one-step (one-pot) thiol-ene and thioacetalization reaction and yields an SH-terminated polymer having at least three terminal thiol groups. An exemplary synthesis route involving DMDO as constituent a2, valeraldehyde as constituent a1 and TAC as constituent a3 is depicted hereinafter:

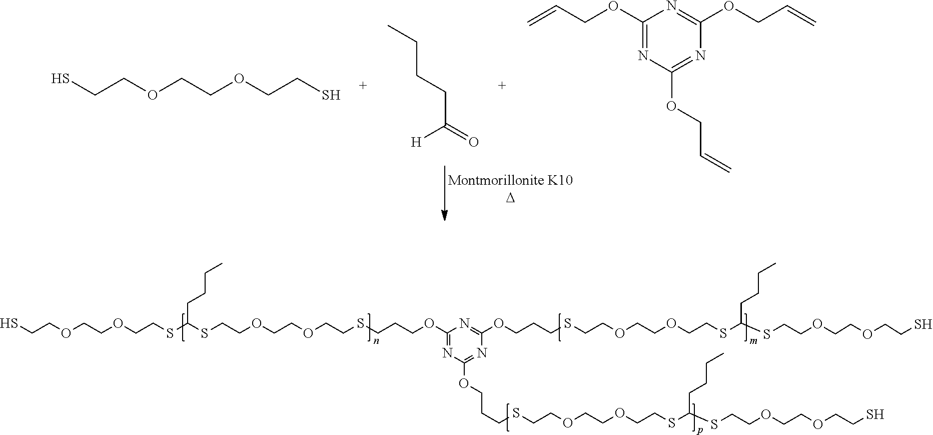

Optionally, the inventive method may comprise a further step 2), in particular when the SH-terminated polymer obtained after the first step 1) is a linear polydithioacetale. Step 2) then represents a step for branching and/or crosslinking the preferably linear SH-terminated polymer obtained after the first step 1) by further reacting the formed polymer having at least two thiol groups with at least one constituent a4, which is suitable to introduce branches and which is different from both constituent a1 and a2 (and also from constituent a3). An example of such a constituent a4 is cyanuric chloride. The resulting SH-terminated polymer obtained after such a second step 2) then has at least three terminal thiol groups. For example, an SH-terminated polymer having at least three terminal thiol groups can be prepared through the reaction of at least one preferably linear SH-terminated polymer having two terminal SH-groups obtained after step 1) and cyanuric chloride, preferably in the presence of a base. The resulting SH-terminated polymer having at least three terminal thiol groups is prepared, e.g., according to the scheme provided hereinafter, in which R is the moiety connecting the two thiol groups of the preferably linear SH-terminated polymer obtained after step 1):

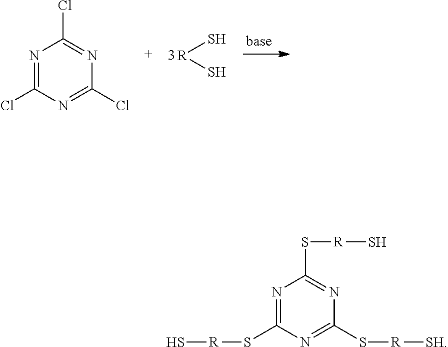

### SH-Terminated Polymer

A further subject-matter of the present invention is an SH-terminated polymer obtainable by the inventive method.

All preferred embodiments described above herein in connection with the inventive method and the preferred embodiments thereof, are also preferred embodiments of the inventive SH-terminated polymer.

### Sealing System

A further subject-matter of the present invention is a two-component (2K) sealing system comprising components (A) and (B) being separate from each other, wherein component (A) of the sealing system comprises at least one inventive SH-terminated polymer or at least one SH-terminated polymer obtainable by the inventive method, and wherein component (B) of the sealing system comprises at least one constituent b0, which is suitable for hardening the sealant composition by at least partially inducing a chemical transformation of the at least two thiol groups of the SH-terminated polymer. Components (A) and (B) of the sealing system can be stored separately until they are mixed with each other in order to prepare the sealant composition.

All preferred embodiments described above herein in connection with the inventive method and the inventive polymers and the preferred embodiments thereof, are also preferred embodiments of the inventive sealant system.

Preferably, the sealing system consists of components (A) and (B).

Each of the two components (A) and (B) of the sealing system may contain water and/or at least one organic solvent. However, it is also possible and even preferably if no organic solvents and/or water are present therein.

The amount of water present in component (A) preferably is less than 3.0 wt.-%, more preferably less than 2.0 wt.-%, even more preferably less than 1.0 wt.-%, still more preferably less than 0.5 wt.-%, in each case based on the total weight of component (A).

The amount of water present in component (B) when at least one constituent b1 and/or at least one constituent b3 and/or at least one constituent b4 is present in each case as constituent b0 in (B) preferably is less than 3.0 wt.-%, more preferably less than 2.0 wt.-%, even more preferably less than 1.0 wt.-%, still more preferably less than 0.5 wt.-%, in each case based on the total weight of component (B). Constituents b1, b3 and b4 will be defined hereinafter.

The amount of water present in component (B) when at least one constituent b2 such as manganese dioxide is present as constituent b0 in (B) preferably is less than 8.5 wt.-%, more preferably less than 7.5 wt.-%, even more preferably less than 7.0 wt.-%, still more preferably less than 6.0 wt.-%, in each case based on the total weight of component (B). Constituent b2 will be defined hereinafter.

If at least one organic solvent is present therein, organic solvent(s) are preferably present in an amount of up to 70 wt.-% or up to 65 wt.-%, based on the total weight of the sealant composition, in particular when the sealant composition is a sprayable composition. In this case the sealant composition preferably includes an organic solvent(s) fraction of up to 60 wt.-%, based in each case on the total weight of the composition. Alternatively, if at least one organic solvent is present therein, in particular, when the sealant composition is not a sprayable composition, organic solvent(s) are preferably present in an amount of up to 10 wt.-%, based on the total weight of the sealant composition. The sealant composition in this case preferably includes an organic solvent(s) fraction of up to 7.5 wt.-%, more preferably of up to 5 wt.-%, based in each case on the total weight of the composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially ethanol and/or propanol, ethers, esters, ketones, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. The solvents present may be identical or different from one another.

Component (A) of the sealing system may additionally contain—besides at least one SH-terminated polymer—at least one filler and/or at least one pigment.

The term “filler” is known to the skilled person, from DIN 55943 (date: October 2001), for example. A “filler” for the purposes of the present invention is preferably a constituent, which is substantially, preferably entirely, insoluble in the medium surrounding them, such as each of components (A) and (B) and the sealant composition, for example, and which is used in particular for adjusting the viscosity and thixotropy of the components and the sealant composition, for adjusting the specific density of the cured sealant and/or for increasing the mechanical properties of the cured sealant. “Fillers” in the sense of the present invention differ from “pigments” in their refractive index, which for fillers is <1.7, while the refractive index for pigments is ≥1.7. Preferably, a “filler” for the purposes of the present invention is an inorganic and/or organic filler. Examples of inorganic fillers are chalk, talcum and aluminum hydroxide. Examples of organic fillers are powders prepared from temperature resistant polymers such as polyamides, polysulfones, polyphenylene sulfides, polyetherketones and polymeric hollow spheres.

Preferably, the amounts of fillers present in component (A) of the sealing system is in the range of from 0 to 55.0 wt.-%, more preferably in the range of from 0 to 50.0 wt.-%, even more preferably in the range of from 0 to 45.0 wt.-%, still more preferably in the range of from 0 to 40.0 wt.-%, yet more preferably in the range of from 0 to 35.0 wt.-% or of from 0 to 30.0 wt.-%, in particular in the range of from 0 to 25.0 wt.-%, in each case based on the total weight of component (A).

Preferably, the amounts of any pigments present in component (A) of the sealing system is in the range of from 0 to 35.0 wt.-%, more preferably in the range of from 0 to 30.0 wt.-%, even more preferably in the range of from 0 to 25.0 wt.-%, still more preferably in the range of from 0 to 20.0 wt.-%, yet more preferably in the range of from 0 to 15.0 wt.-%, in each case based on the total weight of component (A).

The term “pigment” is known to the skilled person from DIN 55943 (date: October 2001), for example. A “pigment” in the sense of the present invention refers preferably to components in powder or flake form which are substantially, preferably entirely, insoluble in the medium surrounding them, such as each of components (A) and (B) and the sealant composition, for example, and which is a colorant and/or substance which can be used as pigment on account of their magnetic, electrical and/or electromagnetic properties. Preferably, a “pigment” for the purposes of the present invention is an inorganic and/or organic pigment. An example of an inorganic pigment is titanium dioxide.

Component (A) may additionally contain and preferably contains at least one curing catalyst, when component (B) of the sealing system comprises at least one constituent b1 comprising two or more epoxide groups as constituent b0. Suitable curing catalysts are amines, in particular tertiary amines, amidines and/or guanidines. Examples are 1,4-diazabicyclo(2.2.2)octane, 1,5-diazabicyclo(4.3.0)non-5-ene (DBN) and 1,8-diazabicyclo(5.4.0)undec-7-ene (DBU).

Component (A) of the sealing system may optionally contain one or more optional constituents:

The optional constituent may be a flame retardant such as a phosphorous-containing flame retardants, in particular at least one phosphate ester. If a flame retardant is used, it preferably is liquid (at 1 bar and 23° C.). In case a flame retardant is present in component (A), it is preferably present therein in an amount of 0.1 to 30.0 wt.-%, more preferably of 1.0 to 25.0 wt.-%, in particular of 5.0 to 20.0 wt.-%, based on the total weight of component (A).

The optional constituent may be a light stabilizer, in particular a UV stabilizers. Examples are for instance sterically hindered amines (HALS: hindered amine light stabilizer). In principle, all commercially available light stabilizers of the Tinuvin® series or from other manufacturers can be used. Liquid light stabilizers are preferred. In case a light stabilizer is present in component (A), it is preferably present therein in an amount of 0.05 to 5.0 wt.-%, more preferably of 0.1 to 3.5 wt.-%, in particular of 0.1 to 2.0 wt.-%, based on the total weight of component (A).

The optional constituent may be an additional adhesion promoter. In particular, organosilanes different from constituent (a2) can be used. Examples are e.g. (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane and/or (3-glycidyloxypropyl)triethoxysilane, vinyltrimethoxysilane. Additionally or alternatively, other adhesion promoters may be used, e.g., titanates and/or zirconates, such as titanium acetylacetonate (TAA) and/or Ti-n-butanolate (TnBt) and/or isopropyl titanate. In case an additional adhesion promoter is present in component (A), it is preferably present therein in an amount of 0.05 to 5.0 wt.-%, more preferably of 0.1 to 3.5 wt.-%, in particular of 0.1 to 2.0 wt.-%, based on the total weight of component (A).

The optional constituent may be an additive selected from the group consisting of defoamers, rheological additives, plasticizers such as phthalates, and viscosity reducers, in particular non-reactive viscosity reducers such as hydrocarbon mixtures based on naphthalene derivatives and/or indene-coumarone resins, tall oil and rapeseed methyl ester (biodiesel) and rapeseed oil and/or other ester-based diluents, as well as mixtures of such additives. In case at least one additive is present in component (A), it is preferably present therein in an amount of 0.05 to 40.0 wt.-%, more preferably of 0.1 to 30.0 wt.-%, in particular of 0.1 to 20.0 wt.-%, based on the total weight of component (A). Specifically, in case at least one defoamer is present, its amount is preferably in the range of from 0.1 to 2.5 wt.-%, based on the total weight of component (A). Specifically, in case at least one reactive diluent is present, its amount is preferably in the range of from 0.1 to 20.0 wt.-%, based on the total weight of component (A). Specifically, in case at least one rheological additive is present, its amount is preferably in the range of from 0.1 to 5.0 wt.-%, based on the total weight of component (A). Specifically, in case at least one plasticizer is present, its amount is preferably in the range of from 0.1 to 2.5 wt.-%, based on the total weight of component (A). Specifically, in case at least one viscosity reducer is present, its amount is preferably in the range of from 0.1 to 20.0 wt.-%, based on the total weight of component (A).

Component (B) of the sealing system comprises at least one constituent b0, which is suitable for hardening the sealant composition by at least partially inducing a chemical transformation of the at least two thiol groups of the SH-terminated polymer. In other words, constituent b0 or part of it can be chemically reacted with the thiol groups of said polymer. Constituent b0 thus represents a curing agent. The resulting chemical transformation may apply to all thiol groups of the polymer or to only part of the thiol groups of the polymer. Preferably, however, a chemical transformation is not only induced partially, but substantially to all thiol groups of the SH-terminated polymer.

Preferably, the least one constituent b0 is selected from the group consisting of constituents comprising two or more epoxide groups (constituents b1), constituents, which are metal oxides and/or metal peroxides, in particular manganese dioxide, (constituents b2), constituents, which are organic peroxides (constituents b3), constituents comprising two or more vinyl groups (constituents b4), and mixtures thereof, more preferably is selected from the group consisting of constituents comprising two or more epoxide groups (constituents b1), constituents, which are metal oxides and/or metal peroxides, in particular manganese dioxide, (constituents b2), and mixtures thereof, in particular represents either at least one constituent comprising two or more epoxide groups as constituent b1 or represents at least one metal oxide and/or metal peroxide, in particular manganese dioxide, as constituent b2.

Preferably, constituent b0 is present in component (B) of the sealing system in an amount in a range of from 30 to 100 wt.-%, based on the total weight of component (B).

Constituent b1 comprises two or more epoxide groups. Preferably, the epoxide groups are present in b1 as terminal groups. Constituent b1 can be monomeric, oligomeric or polymeric. Preferably, b1 is aliphatic and/or aromatic.

Preferably, constituent b1 is present in component (B) of the sealing system in an amount in a range of from 50 to 100 wt.-%, based on the total weight of component (B).

Preferably, b1 has an epoxide functionality of from 2.0 to 5.0, more preferably of from 2.0 to 3.0, in particular of from 2.0 to 2.8.

Constituent b1 is particularly selected from diglycidyl ethers of bisphenol A, diglycidyl ethers of bisphenol F and aliphatic polyglycol and/or hydantoin epoxy derivatives. Also, epoxy-terminated polythioether or polythioethersulfide and/or epoxidized polysulfides may be used. Particularly preferred is also at least one epoxy-novolac resin (epoxidized phenol formaldehyde resin), preferably a cross-linked epoxy novolac resin. It is also possible that more than constituents b1 can be used based on several of the abovementioned classes, for example, bisphenol A/F epoxy resin or bisphenol F novolac resin. Component (B) may additionally contain diluting agents in order to adjust the viscosity and flexibility, for example. Examples of diluting agents are 1,4-butanediol diglycidyl ether, 2-ethylhexyl-glycidyl ether, 1,1,1-trimethylolpropantriglycidylether and 1,6-hexanediol diglycidyl ether.

Preferably, b1 is at least one epoxide-terminated polysulfide polymer and/or polythioether polymer and/or polythioethersulfide polymer without terminal mercapto groups, which serves as a curing agent due to its two terminal epoxide groups. This polymer is preferably present as a liquid or highly viscous polymer with an epoxy equivalent weight in particular in the range from 200 to 800 g/eq.

Preferably, the epoxy (epoxide) equivalent weight of b1 is in the range of from 120 to 800 g/eq, particularly preferably in the range of from 140 to 700 g/eq, and most preferably in the range of from 170 to 400 g/eq.

Most particularly preferred are constituents b1 based on bisphenol A epoxy resins having an epoxy equivalent weight in the range from 170 to 200 g/eq, based on bisphenol F resin having an epoxy equivalent weight in the range from 150 to 180 g/eq and based on epoxy novolac resins having an epoxy equivalent weight in the range from 160 to 220 g/eq.

Examples of suitable commercial products are e.g. bisphenol F epoxy resins such as DEN 354 (Olin Epoxy), bisphenol A resins such as DER 336, DER 331 (Olin Epoxy), bisphenol A/F epoxy resins such as DER 351, DER 324, DER 335 (Olin Epoxy), epoxy novolac resins such as DEN 431, DEN 438, DEN 439 (Olin Epoxy), epoxy-terminated prepolymers based on polysulfide and/or polythioether such as Thioplast EPS 25 (Akzo Nobel), epoxy-terminated reactive diluents based on alcohol/glycols such as 1,4-butanediol diglycidyl ether (DER 731; Olin Epoxy), and 1,6-hexanediol diglycidyl ether (DER 734; Olin Epoxy).

Preferably, the molar ratio of all constituents b1 to all SH-terminated polymers present is in a range of from 0.90:1 to 2:1.

Constituent b2 is at least one metal oxide and/or metal peroxide, in particular manganese dioxide. Manganese dioxide means manganese (IV) oxide. Another suitable constituent b2 is calcium peroxide.

Preferably, constituent b2 is present in component (B) of the sealing system in an amount in a range of from 30 to 90 wt.-%, based on the total weight of component (B).

Constituent b3 is at least one organic peroxide. Examples of suitable organic peroxides are organic hydroperoxides such as cumenyl hydroperoxide.

Preferably, constituent b3 is present in component (B) of the sealing system in an amount in a range of from 30 to 100 wt.-%, based on the total weight of component (B).

Constituent b4 comprises two or more vinyl groups. Preferably, the vinyl groups are present in b4 as terminal groups. Constituent b4 can be monomeric, oligomeric or polymeric, and preferably is monomeric. Preferably, b4 is aliphatic and/or aromatic. Examples of constituent b4 are divinyl ethers such as diethyleneglycol divinyl ether, triethyleneglycol divinyl ether and butandiol divinyl ether.

Preferably, constituent b4 is present in component (B) of the sealing system in an amount in a range of from 30 to 100 wt.-%, based on the total weight of component (B).

If constituent b4 is used as constituent (b) of component (B), it preferably is present in combination with at least one radical generator. Examples of suitable radical generators are 1-hydroxycyclohexyl phenylketone and 2-hydroxy-2-methyl-1-phenylpropane-1-one.

Component (B) of the sealing system may contain one or more optional constituents b5. Constituent b5 may be an additive selected from the group consisting of reactive diluents such as such as bis-oxazolidines and/or aldimines, and plasticizers such as phthalates. In particular, at least one plasticizer constituent b5 is present in component (B), when component (B) of the sealing system comprises at least one constituent b2, in particular manganese dioxide.

Specifically, in case at least one reactive diluent is present, its amount is preferably in the range of from 0.1 to 20.0 wt.-%, based on the total weight of component (B). Specifically, in case at least one plasticizer is present, its amount is preferably in the range of from 10.0 to 70.0 wt.-%, based on the total weight of component (B).

Component (B) may additionally contain and preferably contains at least one curing catalyst b6.

As outlined hereinbefore, when component (B) of the sealing system comprises at least one constituent b1 comprising on turn two or more epoxide groups as constituent b0, at least one curing catalyst if present is preferably present in component (A) as constituent and is not present in component B. Suitable curing catalysts in this case are amines, in particular tertiary amines, amidines and/or guanidines. Examples are 1,4-diazabicyclo(2.2.2)octane, 1,5-diazabicyclo(4.3.0)non-5-ene (DBN) and 1,8-diazabicyclo(5.4.0)undec-7-ene (DBU).

When component (B) of the sealing system comprises at least one constituent b2 as constituent b0, at least one curing catalyst b6 is preferably present in component (B). Suitable curing catalysts in this case are e.g. tetrabenzylthiuram disulfide, diphenylguanidine, and/or zinc bis(diethyldithiocarbamate).

When component (B) of the sealing system comprises at least one constituent b3 as constituent b0, at least one curing catalyst b6 is preferably present in component (B). Suitable curing catalysts in this case are e.g. zinc diethyl carbamate.

When component (B) of the sealing system comprises at least one constituent b4 as constituent b0, at least one curing catalyst b6 is preferably present in component (B). Suitable curing catalysts in this case are in particular suitable photoinitiators such as acetophenones, benzoin ethers and/or benzoyl oximes. Curing preferably takes place via UV light.

Component (B) may additionally contain at least one flame retardant b7. Constituent b7 may be a phosphorous-containing flame retardant, in particular at least one phosphate ester. If a flame retardant is used, it preferably is liquid (at 1 bar and 23° C.).

In case a flame retardant is present in component (A), it is preferably present therein in an amount of 5.0 to 65.0 wt.-%, more preferably of 25.0 to 65.0 wt.-%, in particular of 40.0 to 65.0 wt.-%, based in each case on the total weight of component (B).

### Sealant Composition

A further subject-matter of the present invention is a sealant composition, which is obtainable by mixing components (A) and (B) of the inventive sealing system with each other.

The obtained sealant composition may be sprayable, but does not have to be.

Preferably, the sealant composition is obtainable by mixing components (A) and (B) in a weight ratio (component (A)/component (B)) in the range of from 100:1 to 1:1. More preferably, mixing is performed in a weight ratio in the range of from 100:1 to 1.1:1, even more preferably in a weight ratio in the range of from 100:1 to 2:1, in particular in a weight ratio in the range of from 100:1 to 3:1, most preferred in a weight ratio in the range of from 20:1 to 4:1.

All preferred embodiments described above herein in connection with the inventive method, the inventive polymers and the inventive sealing system and the preferred embodiments thereof, are also preferred embodiments of the inventive sealant composition.

### Sealing Method

A further subject-matter of the present invention is a method of sealing an optionally pre-coated substrate comprising at least a step of applying an inventive sealant composition at least in portion onto a surface of an optionally pre-coated substrate, wherein the optionally pre-coated substrate preferably is a substrate utilizable in the aerospace and/or aircraft industry.

All preferred embodiments described above herein in connection with the inventive method, the inventive polymers and the inventive sealing system and sealant composition, and the preferred embodiments thereof, are also preferred embodiments of the inventive sealing method.

The substrate may be optionally pre-coated. For example, it may already bear a primer film at least in portion on its surface. The substrates used may additionally or alternatively be subjected to a pretreatment leading to another pre-coating. For example, an epoxy-based coating may be applied and the substrates used bear at least one preferably cured coating layer such as an epoxy-based coating layer.

Suitable substrates are metallic substrates, but also plastic substrates such as polymeric substrates and/or fiber-based composites can be used. Preferred substrates are substrates utilizable in the aerospace and/or aircraft industry such as fuel tanks. Preferably, the surface to be sealed in this case is the inner surface of a fuel tank.

Suitability as metallic substrates used in accordance with the invention are all substrates used customarily and known to the skilled person. The substrates used in accordance with the invention are preferably metallic substrates including steel substrates and titanium substrates. Most preferred, however, are aluminum and/or aluminum alloy substrates.

Preferably, thermoplastic polymers are used in case the substrates are plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

However, as outlined above fiber-based composites such as carbon fiber composites may also be used as substrates.

Preferably, the inventive sealing method further comprises a curing step, namely curing at least the sealant composition applied at ambient temperature (18 to 23° C.) or at an elevated temperature such as 80° C. for 0.5 hours to 14 days. Preferably, curing means chemical curing such as chemical crosslinking, at ambient temperature or at an elevated temperature. In case of using at least one constituent (b1) or (b4) as constituent (b), curing may additionally or alternatively be induced via UV light.

Preferably, the sealant composition is applied in a dry layer thickness in the range of from 15 μm to 20 mm, more preferably of from 50 μm to 15 mm, in particular of from 0.5 to 10 mm.

### Sealed Substrate

A further subject-matter of the present invention is a sealed substrate, obtainable by the inventive method.

All preferred embodiments described above herein in connection with the inventive method, the inventive polymers and the inventive sealing system and sealant composition as well as the inventive sealing method, and the preferred embodiments thereof, are also preferred embodiments of the inventive sealed substrate.

### Inventive Use

A further subject-matter of the present invention is a use of the inventive sealing system or of the inventive sealant composition for providing a sealing at least in portion onto a surface of an optionally pre-coated substrate, which is preferably utilizable in the aerospace and/or aircraft industry.

All preferred embodiments described above herein in connection with the inventive method, the inventive polymers and the inventive sealing system and sealant composition as well as the inventive sealing method and the inventive sealed substrate, and the preferred embodiments thereof, are also preferred embodiments of the aforementioned inventive use.

### Methods

### 1. Hardness

Shore A hardness was measured according to AITM 1-0033, ISO 48-4, ISO 868.

### 2. Tensile Strength and Elongation at Break

Tensile strength and elongation were measured according to ISO 37 Type 2.

### 3. Immersion Test

The immersion test was performed according to AIMS 04-05-001, AIMS 04-05-007 either at 60° C. (H₂O) or at 100° C. (JetA1). 4. DMTA measurements DMTA (dynamic-mechanical-thermo-analysis) measurements were performed with a GABO Qualimeter and the software Eplexor 8.375. The following measurement parameters were applied: measuring frequency: 10 Hz, Heating rate: 2K/min; Temperature range: −50/−50° C. to +30° C. Samples with a thickness of 3 mm, a width of 10 mm and a length of 35-40 mm were tested in the tension mode. Prior to the measurement the samples were cured for 14 days at 23° C., 50% r.F. The Tg-peak is defined as the temperature where the tan 5 has its maximum. The Tg-onset is defined as the temperature intersection of extrapolated tangents drawn from points on the curve before and after the drop of the storage modulus E′.

### 5. Number Average Molecular Weight (Mn)

The number average molecular weight is determined through GPC (gel permeation chromatography) against polystyrene standards. THF (tetrahydrofurane) is used as a mobile phase or calculated based on the SH content.

### 6. SH Content

The SH content in wt.-% is determined via titration. The terminal SH-groups are oxidized by iodine to disulfide groups. The SH content can be then calculated from the iodine consumption.

### Examples

The following examples further illustrate the invention but are not to be construed as limiting its scope. ‘Pbw’ means parts by weight. If not defined otherwise, ‘parts’ means ‘parts by weight’.

### 1. Synthesis of SH-Terminated Polydithioacetales

### 1.1 Examples 1a, 1b and 1d (Inventive) and 1c and 1e (Comparative)

### Example 1a: Synthesis of Linear Polydithioacetales with a Liquid Acid Catalyst

In a 500 ml 3-neck flask, equipped with dropping funnel, condenser and gas control valve (for introduction of argon) 75.33 g (0.413 mol) 2,2′-(Ethylenedioxy)diethanethiol (DMDO), 80 mL 1,4-dioxane and 6.1 g 37% aqueous HCl solution were mixed and stirred under argon. This mixture was cooled to 0° C. with an ice bath. Valeraldehyde (32.14 g, 0.362 mol) was slowly dropped into the solution under stirring. After the complete addition, the dropping funnel was washed with 20 mL 1,4-dioxane. This mixture was further stirred at 0° C. for 2 hours. Then the mixture was heated to 85° C. and stirred under argon for 10 hours. Afterwards the reaction mixture was cooled to room temperature and evaporated in vacuum at 85° C./12 mbar. 101.07 g of viscous oil with 3.6 wt.-% SH (calculated value: 3.4 wt.-%) with Mn (calculated) of about 1830 g/mol was obtained.

### Examples 1b, 1d (Inventive) and 1c and 1e (Comparative)

Example 1a was repeated with the exception that valeraldehyde was replaced with an equimolar amount of paraldehyde (acetaldehyde trimer; 3 mol acetaldehyde is equal to 1 mol paraldehyde, therefore ⅓ paraldehyde amount of the amount of acetaldehyde has to be used; example 1b), 3-methoxybenzahldehyde (example 1c), and iso-butyraldehyde (example 1d) and 3,4-dimethoxy benzaldehyde (example 1e). In case of example 1c an oily product with 2.1 wt.-% SH and with Mn (calculated) of about 3140 g/mol was obtained. In case of example 1e, a glassy polymeric product was obtained, which could not be further processed.

### 1.2 Examples 2a and 2b (Inventive)

### Example 2a: Synthesis of Linear Polydithioacetales with a Liquid Acid Catalyst

In a 250 ml 3-neck flask, equipped with dropping funnel, condenser and gas control valve (for introduction of argon) 20.30 g (0.111 mol) 2,2′-(Ethylenedioxy)diethanethiol (DMDO), 50 mL 1,4-dioxane, 4 ml H₂O and 2.27 g 37% aqueous HCl solution were mixed and stirred under argon. This mixture was cooled to 0° C. with an ice bath. Acetaldehyde diethyl acetal (11.51 g, 0.0974 mol) was slowly dropped into the solution under stirring. After the complete addition, the dropping funnel was washed with 15 mL 1,4-dioxane. This mixture was further stirred at 0° C. for 2 hours. Then the mixture was heated to 85° C. and stirred under argon for 10 hours. Afterwards the reaction mixture was cooled to room temperature and evaporated in vacuum at 85° C./12 mbar. 22.94 g of viscous oil with 3.4 wt.-% SH (calculated value: 4.01 wt.-%) with Mn (calculated) of about 1940 g/mol was obtained.

### Example 2b

Example 2a was repeated with the exception that acetaldehyde diethyl acetal was replaced with an equimolar amount of formaldehyde diethyl acetal (after storage at room temperature product turned from liquid to waxy).

### 1.3 Examples 3a to 3e (Inventive)

### Example 3a: Synthesis of Branched Polydithioacetales with a Liquid Acid Catalyst

In a 500 ml 3-neck flask, equipped with dropping funnel, condenser and gas control valve (for introduction of argon) 60.00 g (0.329 mol) 2,2′-(Ethylenedioxy)diethanethiol (DMDO), 180 mL 1,4-dioxane and 1.37 g 50 wt.-% aqueous glutaraldehyde solution were mixed and stirred under argon. This mixture was cooled to 0° C. with an ice bath. The mixture of 7 g aqueous 37% HCl solution and 12 g H₂O was slowly dropped into the solution under stirring. This mixture was further stirred at 0° C. for two hours. Acetaldehyde diethyl acetal (35.00 g, 0.296 mol) was slowly dropped into the solution under stirring. After the complete addition, the dropping funnel was washed with 20 mL 1,4-dioxane. The mixture was further stirred at 0° C. for 2 hours. Then the mixture was heated to 85° C. and stirred under argon for 10 hours. Afterwards the reaction mixture was cooled to room temperature and evaporated in vacuum at 85° C./12 mbar. 68.24 g of viscous oil with 1.8 wt.-% SH (calculated value: 1.85 wt.-%) was obtained.

### Examples 3b, 3c, 3d and 3e

Example 3a was repeated with the exception that a higher amount of the 50 wt.-% aqueous glutaraldehyde solution was used, namely an amount corresponding to 2.5 mol-% glutaraldehyde (example 3b) or to 2.9 mol-% (example 3c) or to 3.2 mol-% (example 3d; in this case a solid product was obtained). More specifically, for example 3b 60 g DMDO (0.329 mol), 1.60 g (0.008 mol) 50 wt.-% aqueous glutaraldehyde solution, 34.74 g (0.294 mol) acetaldehyde diethyl acetal, 200 mL 1,4-dioxane, 7 g aqueous 37% HCl solution and 12 g H₂O were used. For example, 3c 60 g DMDO (0.329 mol), 1.80 g (0.009 mol) 50 wt.-% aqueous glutaraldehyde solution, 34.51 g (0.292 mol) acetaldehyde diethyl acetal, 200 mL 1,4-dioxane, 7 g aqueous 37% HCl solution and 12 g H₂O were used. For example, 3d 60 g DMDO (0.329 mol), 2.06 g (0.010 mol) 50 wt.-% aqueous glutaraldehyde solution, 34.20 g (0.289 mol) acetaldehyde diethyl acetal, 200 mL 1,4-dioxane, 10.5 g aqueous 37% HCl solution and 18 g H₂O were used. Example 3a was repeated with the exception that no solvent (1,4-dioxane) was used (example 3e).

### 1.4 Examples 4a to 4k (Inventive)

Example 4a: Synthesis of linear polydithioacetales with a solid acid catalyst 9.87 g DMDO (54.1 mmol) and 0.49 g montmorillonite K10 were charged into a 100 mL 3-neck flask. The reaction mixture was stirred at room temperature under nitrogen flush for 20 minutes. 4 g valeraldehyde (46.4 mmol) was then added dropwise over a period of 45 minutes. After complete addition of valeraldehyde, the reaction mixture was heated to 95° C. then held 6 hours or held 3 hours at 95° C. and held another 3 hours at 115° C. The reaction mixture was then cooled to room temperature and the catalyst was filtered off via vacuum filtration. To obtain quantitative yield, the catalyst was washed with ethyl acetate after the filtration step and product of example 4a was collected after the evaporation of ethyl acetate using a rotational evaporator.

### Examples 4b to 4k

Example 4a was repeated with the exception that 0.98 g (example 4b), 1.96 g (example 4c), 0.29 g (example 4d) or 0.098 g (example 4e) of montmorillonite K10 were used. Example 4a was repeated with the exception that montmorillonite K10 was replaced with 1.96 g (example 4f) or 0.49 g (example 4g) of Amberlyst® 15 or with 1.96 g (example 4h) or 0.49 g (example 4i) of Dowex® 50W X8 and with the exception that in each case 10 mL 1,4-dioxane were used as solvent. Example 4a was repeated with the exception that 11.64 g DMDO, 3.95 g iso-butyraldehyde and 0.57 g montmorillonite K10 were used. The aldehyde was added at room temperature in 45 minutes and the mixture was afterwards heated for 6 h at 95° C. (example 4j). Example 4a was repeated with the exception that 11.47 g DMDO, 4.0 g butyraldehyde and 0.57 g montmorillonite K10 were used. The aldehyde was added at room temperature in 45 minutes and the mixture was afterwards heated for 6 h at 95° C. (example 4k).

### 1.5 Examples 5a to 5f (Inventive)

Example 5a: Synthesis of branched polydithioacetales with a solid acid catalyst 9.87 g DMDO (54.1 mmol), 0.24 g glutaraldehyde (50% solution in H₂O) and 0.49 g montmorillonite K10 were charged into a 100 mL 3-neck flask. The reaction mixture was stirred at room temperature under nitrogen flush for 20 minutes. 4 g valeraldehyde (46.4 mmol) was then added dropwise over a period of 45 minutes. After complete addition of valeraldehyde, the reaction mixture was heated to 95° C. then held 3 hours and then heated to 115° C. and held for another 3 hours. The reaction mixture was then cooled to room temperature and the catalyst was filtered off via vacuum filtration. To obtain quantitative yield, the catalyst was washed with ethyl acetate after the filtration step and product of example 4a was collected after the evaporation of ethyl acetate using a rotational evaporator.

### Examples 5b to 5 g

Example 5a was repeated with the exception that 0.98 g (example 5b), 1.96 g (example 5c) or 0.29 g (example 5d) of montmorillonite K10 were used. Example 5a was repeated with the exception that 0.29 g glutaraldehyde (50% solution in H₂O) were used (example 5e). Example 5e was repeated with the exception that 10 mL 1,4-dioxane were used as solvent (example 5f). Example 5a was repeated with the exception that instead of glutaraldehyde (50% solution in H₂O) 4.0 g of valeraldehyde and 0.18 g of terephthaldehyde were used (example 5g).

### 1.6 Examples 6a and 6b (Inventive)

Example 6a: In a 250 ml 3-neck flask, equipped with dropping funnel, condenser and gas control valve (for introduction of argon) 21.15 g (0.116 mol) 2,2′-(Ethylenedioxy)diethanethiol (DMDO), 40 mL 1,4-dioxane and 1.14 g 37% aqueous HCl solution were mixed and stirred under argon. This mixture was cooled to 0° C. with an ice bath. Valeraldehyde (8.74 g, 0.0984 mol) was slowly dropped into the solution under stirring. After the complete addition, the dropping funnel was washed with 20 mL 1,4-dioxane. This mixture was further stirred at 0° C. for 2 hours. Then the mixture was heated to 85° C. and stirred under argon for 10 hours. Afterwards the reaction mixture was cooled to room temperature and evaporated in vacuum at 85° C./12 mbar. 28.2 g of viscous oil with 4.1 wt.-% SH (calculated value: 3.4 wt.-%) with Mn (calculated) of about 1610 g/mol was obtained.

Example 6b: In a 100 ml 3-neck flask, equipped with dropping funnel, condenser and gas control valve (for introduction of argon) 10.57 g (0.0058 mol) 2,2′-(Ethylenedioxy)diethanethiol (DMDO), 20 mL 1,4-dioxane and 0.57 g 37% aqueous HCl solution were mixed and stirred under argon. This mixture was cooled to 0° C. with an ice bath. Valeraldehyde (4.51 g, 0.0508 mol) was slowly dropped into the solution under stirring. After the complete addition, the dropping funnel was washed with 10 mL 1,4-dioxane. This mixture was further stirred at 0° C. for 2 hours. Then the mixture was heated to 85° C. and stirred under argon for 10 hours. Afterwards the reaction mixture was cooled to room temperature and evaporated in vacuum at 85° C./12 mbar. 14.12 g of viscous oil with 3.4 wt.-% SH (calculated value: 2.5 wt.-%) with Mn (calculated) of about 1940 g/mol was obtained.

### 2. Preparation of Sealant Compositions

2.1 A number of exemplary sealant compositions were prepared. Each of the sealant compositions was prepared from mixing two components (A) and (B) of a two-component sealing system with each other. Sealant examples S-1a, S-3a, S-3b, S-3c, S-2a, S-2b, S-1d, S2a1d, S-6a and S-6b are inventive examples. Sealant example S-1c is a comparative example.

### 2.2 Sealant Example S-1a

The composition of component (A) of sealing system S-1a is given in Table 1. Component (A) is prepared from mixing the constituents listed in Table 1 with each other in the order given in Table 1.

TABLE 1
Composition of the “A”-component

| Constituent | Amount [g] |
|---|---|
| Linear polydithioacetale of | 65.00 |
| example 1a | |
| Amine catalyst | 1.30 |
| Filler | 25.90 |

Dabco 33 LV was used as amine catalyst. Aluminum hydroxide was used as filler.

92.2 g of component “A” was mixed with a hardener component “B”, which consists of 12.48 g of a commercially available epoxy resin (Novolak DEN 431).

### 2.3 Sealant Example S-3a

The composition of component (A) of sealing system S-3a is given in Table 2. Component (A) is prepared from mixing the constituents listed in Table 2 with each other in the order given in Table 2.

TABLE 2
Composition of the “A”-component

| Constituent | Amount [g] |
|---|---|
| Branched polydithioacetale | 62.00 |
| of example 3a | |
| Amine catalyst | 0.62 |
| Filler | 22.70 |

Dabco 33 LV was used as amine catalyst. Aluminum hydroxide was used as filler.

85.32 g of component “A” was mixed with a hardener component “B”, which consists of 5.95 g of a commercially available epoxy resin (Novolak DEN 431).

### 2.4 Sealant Example S-3b

The composition of component (A) of sealing system S-3b is given in Table 3. Component (A) is prepared from mixing the constituents listed in Table 3 with each other in the order given in Table 3.

TABLE 3
Composition of the “A”-component

| Constituent | Amount [g] |
|---|---|
| Branched polydithioacetale | 58.00 |
| of example 3b | |
| Amine catalyst | 0.58 |
| Filler | 21.40 |

Dabco 33 LV was used as amine catalyst. Aluminum hydroxide was used as filler.

79.98 g of component “A” was mixed with a hardener component “B”, which consists of 5.57 g of a commercially available epoxy resin (Novolak DEN 431).

### 2.5 Sealant Example S-3c

The composition of component (A) of sealing system S-3c is given in Table 4. Component (A) is prepared from mixing the constituents listed in Table 4 with each other in the order given in Table 4.

TABLE 4
Composition of the “A”-component

| Constituent | Amount [g] |
|---|---|
| Branched polydithioacetale | 62.00 |
| of example 3c | |
| Amine catalyst | 0.62 |
| Filler | 23.00 |

Dabco 33 LV was used as amine catalyst. Aluminum hydroxide was used as filler.

85.62 g of component “A” was mixed with a hardener component “B”, which consists of 6.28 g of a commercially available epoxy resin (Novolak DEN 431).

### 2.6 Sealant Example S-2a

The composition of component (A) of sealing system S-2a is given in Table 5. Component (A) is prepared from mixing the constituents listed in Table 5 with each other in the order given in Table 5.

TABLE 4
Composition of the “A”-component

| Constituent | Amount [g] |
|---|---|
| Linear polydithioacetale of | 6.73 |
| example 2a | |
| Amine catalyst | 0.10 |

DBU was used as amine catalyst.

6.83 g of component “A” was mixed with a hardener component “B”, which consists of 1.22 g of a commercially available epoxy resin (Novolak DEN 431).

### 2.7 Sealant Example S-2b

The composition of component (A) of sealing system S-2b is given in Table 6. Component (A) is prepared from mixing the constituents listed in Table 6 with each other in the order given in Table 6.

TABLE 6
Composition of the “A”-component

| Constituent | Amount [g] |
|---|---|
| Linear polydithioacetale of | 7.06 |
| example 2b | |
| Amine catalyst | 0.10 |

DBU was used as amine catalyst.

7.16 g of component “A” was mixed with a hardener component “B”, which consists of 1.28 g of a commercially available epoxy resin (Novolak DEN 431).

### 2.8 Sealant Example S-1c

The composition of component (A) of sealing system S-1c is given in Table 7. Component (A) is prepared from mixing the constituents listed in Table 7 with each other in the order given in Table 7.

TABLE 7
Composition of the “A”-component

| Constituent | Amount [g] |
|---|---|
| Linear polydithioacetale of | 9.25 |
| example1c | |
| Amine catalyst | 0.13 |

DBU was used as amine catalyst.

9.38 g of component “A” was mixed with a hardener component “B”, which consists of 1.03 g of a commercially available epoxy resin (Novolak DEN 431).

### 2.9 Sealant Example S-1d

The composition of component (A) of sealing system S-1d is given in Table 8. Component (A) is prepared from mixing the constituents listed in Table 8 with each other in the order given in Table 8.

TABLE 8
Composition of the “A”-component

| Constituent | Amount [g] |
|---|---|
| Linear polydithioacetale of | 7.97 |
| example1d | |
| Amine catalyst | 0.10 |

DBU was used as amine catalyst.

8.07 g of component “A” was mixed with a hardener component “B”, which consists of 1.36 g of a commercially available epoxy resin (Novolak DEN 431).

### 2.10 Sealant Example S-2a1d

The composition of component (A) of sealing system S-2a1d is given in Table 9. Component (A) is prepared from mixing the constituents listed in Table 9 with each other in the order given in Table 9.

TABLE 9
Composition of the “A”-component

| Constituent | Amount [g] |
|---|---|
| Linear polydithioacetales of | 5.28 + 1.32 |
| examples 2a and 1d (mixed | |
| in a 4:1 weight ratio | |
| Amine catalyst | 0.10 |

DBU was used as amine catalyst.

6.70 g of component “A” was mixed with a hardener component “B”, which consists of 1.25 g of a commercially available epoxy resin (Novolak DEN 431).

### 2.11 Sealant Examples S-6a and S-6b

The composition of component (A) of sealing system S-6a is given in Table 10. Component (A) is prepared from mixing the constituents listed in Table 10 with each other in the order given in Table 10.

TABLE 10
Composition of the “A”-component

| Constituent | Amount [g] |
|---|---|
| Linear polydithioacetales of | 7.31 |
| examples 6a | |
| Amine catalyst | 0.12 |

DBU was used as amine catalyst.

7.43 g of Component “A” was mixed with a hardener component “B”, which consists of 1.6 g of a commercially available epoxy resin (Novolak DEN 431).

The composition of component (A) of sealing system S-6b is given in Table 11. Component (A) is prepared from mixing the constituents listed in Table 11 with each other in the order given in Table 11.

TABLE 11
Composition of the “A”-component

| Constituent | Amount [g] |
|---|---|
| Linear polydithioacetales of | 6.17 |
| examples 6b | |
| Amine catalyst | 0.12 |

DBU was used as amine catalyst.

6.29 g of Component “A” was mixed with a hardener component “B”, which consists of 1.12 g of a commercially available epoxy resin (Novolak DEN 431).

2.12 After each of the aforementioned components “A” had been mixed with component “B” using a speed mixer, the resulting mixture was then poured into a Teflon molding and the resulting sealant compositions were cured for 14 days within the moldings at room temperature (23° C.) and 50% relative humidity. The resulting test specimen were then subjected to a number of tests as it will be outlined hereinafter.

### 3. Investigation of Properties of Sealed Substrates

3.1 Some properties of some of the sealed and cured substrates as well have been investigated. The measurements have been performed according to the methods disclosed in the ‘methods’ section. The results are displayed in Table 12.

TABLE 12
(inventive sealants S-1a, S-3a, S-3b and S-3c)

| | Sealant | Sealant | Sealant | Sealant |
|---|---|---|---|---|
| | S-1a | S-3a | S-3b | S-3c |
| Tensile strength | 1.10 | 1.48 | 1.44 | 1.38 |
| [MPa] | | | | |
| Elongation | 236 | 265 | 170 | 258 |
| [%] | | | | |
| Shore A | 27.8/22.9 | 28.8/26.1 | 41.9/39.1 | 29.3/25.7 |
| hardness (max./3 | | | | |
| seconds value) | | | | |
| T_{g} onset, DMTA | −44 | −44 | −43 | −43 |
| [° C.] | | | | |
| T_{g} peak, DMTA [° C.] | −34 | −39 | −38 | −36 |
| Tensile strength after | 1.30 | 1.37 | 1.40 | 1.43 |
| 14 days of storage | | | | |
| at 100° C. | | | | |
| (JetA1) [Mpa] | | | | |
| Elongation after 14 | 174 | 194 | 137 | 159 |
| days of storage | | | | |
| at 100° C. (JetA1) | | | | |
| [%] | | | | |
| Tensile strength | 1.10 | 0.58 | 0.78 | 0.82 |
| after 14 days of | | | | |
| storage at 60° C. | | | | |
| (H₂O) | | | | |
| [Mpa] | | | | |
| Elongation after 14 | 310 | 266 | 152 | 196 |
| days of storage at | | | | |
| 60° C. (H₂O) | | | | |
| [%] | | | | |

3.2 Further properties of some of the sealed and cured substrates have been investigated. The measurements have been performed according to the methods disclosed in the ‘methods’ section. The results are displayed in Table 13.

TABLE 13
(inventive sealants S-2a, S-2b, S2a1d, S-6a
and S-6b and comparative sealant S-1c)

| | Sealant | Sealant | Sealant | Sealant | Sealant | Sealant |
|---|---|---|---|---|---|---|
| | S-2a | S-2b | S-1c | S-2a1d | S-6a | S-6b |
| T_{g} onset, | −42 | −45 | −11 | −42 | −40 | −42 |
| DMTA [° C.] | | | | | | |
| T_{g} peak, | −32 | −34 | +3 | −34 | −29 | −33 |
| DMTA [° C.] | | | | | | |
| Weight | 4 | nd | nd | nd | 7 | 5 |
| reduction | | | | | | |
| after | | | | | | |
| storage in | | | | | | |
| jet fuel | | | | | | |
| (immersion | | | | | | |
| test) [wt.-%] | | | | | | |

nd = not determined

The weight reduction test was performed as a pre-test in order to get an impression of the jet fuel resistance (JetA1) of the prepared sealants. Samples with a thickness of 3 mm, a width of 10 mm and a length of 60 mm were tested. Prior to the measurement the samples were cured for 14 days at 23° C., 50% r. F. In order to evaluate the jet fuel resistance, the weight of the described samples was determined with an analytic scale. Afterwards the samples were stored for 7 days at 100° C. in JetA1. After the immersion, the weight of the samples was determined again with an analytic scale. The weight reduction (comparing the weight prior and after the immersion into jet fuel) gave an idea about the jet fuel resistance of the prepared samples.

As it is evident from Tables 12 and 13, each of the inventive sealants prepared from constituents a1 having an aliphatic structure showed excellent low T_{g} onset values as measured by DMTA in a range of from −29 to −44° C. In contrast, comparative sealant S-1c exhibited a significantly higher T_{g} onset value of −11° C., which makes it not suitable for use as sealant, in particular in the aerospace industry.

1. A polycondensation method for preparing an SH-terminated polymer having at least two terminal thiol groups and comprising sulfur-carbon-sulfur linkages in its polymer backbone, wherein the method comprises a step of
reacting at least one organic constituent a1 having an aliphatic structure and comprising at least one carbonyl group with at least one organic constituent a2 being different from constituent a1 and comprising at least two thiol groups as step 1) to prepare the SH-terminated polymer,
wherein constituent(s) a1 is/are selected from aldehydes having at least one aldehyde group, O-acetals of these aldehydes, ketones having at least one keto group, and mixtures thereof,
wherein the two sulfur atoms of the at least two thiol groups of constituent(s) a2 are separated from each other by a linker moiety L having a chain of at least four atoms, and
wherein a molar ratio r of constituent(s) a1 and a2 to each other is in a range of from 0.82 to 0.99.

2. The method according to claim 1, wherein the molar ratio r of constituent(s) a1 to constituent(s) a2 is in a range of from 0.85 to 0.99.

3. The method according to claim 1, wherein the number average molecular weight (Mn) of the SH-terminated polymer is in a range of from 500 to 15 000 g/mol.

4. The method according to claim 1, wherein the SH-terminated polymer has an SH-content in a range of from 1.0 wt.-% to 10.0 wt.-% based on the total weight of the SH-terminated polymer.

5. The method according to claim 1, wherein step 1) is catalyzed via at least one acid, which can be a liquid acid or a solid acid.

6. The method according to claim 1, wherein at least a part of the sulfur-carbon-sulfur linkages present in the polymer backbone is present as divalent —S—CR^{x}R^{y}—S— moieties within the backbone,
wherein each of R^{x} and R^{y} is independently of one another selected from the group consisting of H, C₁-C₂₀ aliphatic radicals, C₁-C₂₀ heteroaliphatic radicals, C₃-C₂₀ cycloaliphatic radicals, 3-20 membered heterocycloaliphatic radicals, C₃-C₂₀ cycloaliphatic radicals bonded via a C₁₋₁₀ aliphatic radical, and 3-20-membered heterocycloaliphatic radicals bonded via a C₁₋₁₀-aliphatic radicals.

7. The method according to claim 1, wherein the SH-terminated polymer is
a linear polymer, or is
a branched polymer, when (i) two kinds of constituents a1 are used and the first constituent a1 has precisely one carbonyl group and the second constituent a1 has two or more carbonyl groups, and constituent(s) a2 has/have at least two thiol groups, or when (ii) constituent(s) a1 has/have at least one carbonyl group and at least one of the constituents a2 used has at least three thiol groups.

8. The method according to claim 1, wherein the two sulfur atoms of the at least two thiol groups of constituent(s) a2 is/are separated from each other by a linker moiety L having a chain of at least four, wherein said atoms are carbon atoms, wherein optionally one or more of these carbon atoms may be replaced by a heteroatom.

9. The method according to claim 1, wherein at least one of the constituent(s) a2 used comprises divalent oxygen atoms, wherein R^{a2} is a C₂ to C₈ alkylene residue, and parameter n is an integer in a range of from 1 to 200.

10. The method according to claim 1, wherein the SH-terminated polymer contains at least repeating units of the general formula (RU1), 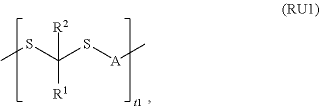
wherein
R¹ and R² together with the carbon atom connecting them represent the constituent a1 without the oxygen atom of the formerly present carbonyl group, said carbonyl groups having been the only carbonyl group present in a1,
t1 is an integer in a range of from 2 to 300, and variable A represents the remaining part of constituent a2 before reaction with constituent a1, i.e.,—constituent a2 without the thiol groups, said thiol groups having been precisely two in a2,
and in that the SH-terminated polymer optionally, in case it is a branched polymer, further comprises at least one repeating unit (RU2), 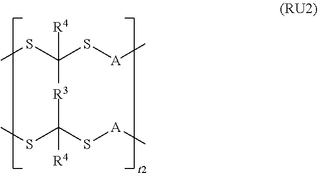
wherein
R³ and each R⁴ together with the two carbon atoms connection them represent constituent a1 without each of the oxygen atoms of the formerly present two carbonyl groups, said two carbonyl groups having been the only carbonyl groups present in a1,
t2 is an integer in a range of from 1 to 25, and
variable A represents constituent a2 without the thiol groups, said thiol groups having been precisely two in a2.

11. The method according to claim 1, wherein at least one further constituent a3 is used in step 1) besides constituent(s) a1 and a2, said constituent a3 being different from both constituents a1 and a2 and bearing at least three ethylenically unsaturated groups, the additional presence of constituent a3 allowing performance of a thiol-ene and thioacetalization reaction in a one-step reaction within step 1) of the method and yielding an SH-terminated polymer having at least three terminal thiol groups,
and/or in that the method comprises a further step 2), when the SH-terminated polymer obtained after the first step 1) is linear, said step 2) representing a step for branching and/or crosslinking the linear SH-terminated polymer obtained after the first step 1) by further reacting it with at least one constituent a4, which is suitable to introduce branches and which is different from both constituent a1 and a2 and also from optional constituent a3, resulting in an SH-terminated polymer obtained after such a second step 2) having at least three terminal thiol groups.

12. An SH-terminated polymer obtained by the method according to claim 1.

13. A two-component (2K) sealing system comprising components (A) and (B) being separate from each other, wherein component (A) of the sealing system comprises at least one SH-terminated polymer according to claim 12, and wherein component (B) of the sealing system comprises at least one constituent b0, which is suitable for hardening the sealant composition by at least partially inducing a chemical transformation of the at least two thiol groups of the SH-terminated polymer.

14. The sealing system according to claim 13, wherein the at least one constituent b0, which is present in component (B) and is suitable for hardening the sealant composition, is selected from the group consisting of constituents comprising two or more epoxide groups (constituents b1), constituents, which are metal oxides and/or metal peroxides, (constituents b2), constituents, which are organic peroxides (constituents b3), constituents comprising two or more vinyl groups (constituents b4), and mixtures thereof.

15. A sealant composition, which is obtained by mixing components (A) and (B) of a sealing system according to claim 13 with each other.

16. A method of sealing an optionally pre-coated substrate comprising at least a step of applying a sealant composition according to claim 15 at least in portion onto a surface of an optionally pre-coated substrate.

17. A sealed substrate obtained by the method according to claim 16.

18. A method of using the sealing system according to claim 13, the method comprising using the sealing system for providing a sealing at least in portion onto a surface of an optionally pre-coated substrate, which is utilizable in the aerospace and/or aircraft industry.

19. The method according to claim 1, wherein the molar ratio r of constituent(s) a1 to constituent(s) a2 is in a range of from 0.86 to 0.99.

20. The method according to claim 1, wherein the number average molecular weight (Mₙ) of the SH-terminated polymer is in a range of from 600 to 10000 g/mol.
